(19) United States
(12) Patent Application Publication
(10) Pub. No.: US 2006/0239479 A1
(43) Pub. Date: Oct. 26, 2006

(54) Transmission of acoustic vibrations to a surface over the display of a mobile device

(75) Inventors: Daniel Willem Elisabeth Schobben, Eindhoven (NL); Martinus Hermanus Wilhelmus Maria Van Delden, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koninklijke Philips Electronics N.V.

(21) Appl. No.: 10/555,257

(22) PCT Filed: May 3, 2004
(86) PCT No.: PCT/IB04/50565

§ 371 Date: Nov. 1, 2005

(30) Foreign Application Priority Data
May 6, 2003 (EP) 03101252.9

(51) Int. Cl. H04R 5/02

(52) U.S. Cl. 381/306

(57) ABSTRACT

Mobile device having a sound generating means and a display. The mobile device (1) comprises a display (2) with means (3) for acoustically exciting the display or a part of the display. In order to increase the sound volume, particularly at low frequencies, the mobile device is arranged such that when the mobile device is positioned on a table top as defined in this application, the sound volume at a frequency between 0.5 kHz and 1.5 kHz at a 1 meter's distance from the mobile device is increased by at least 6 dB as compared to the same device when used in air.

The invention relates to a mobile device having a sound generating means and a display. Such devices are for instance mobile phones, PDAs (personal digital assistants), remote controls etc

Such devices are widely used. These devices comprise a means for generating sound as well as a display for displaying images. In portable applications, like in the case of a mobile phone, sound is more or less private.

Under most circumstances this is sufficient. However, there are instances where multiple user listening is desirable.

One method to enable multiple user listening is turning up the volume. In practice, however, this is not very useful because there are restrictions to the maximum sound intensity that may be produced by a mobile phone. In addition, producing low frequency sound at substantially larger exciter-ear distances (D) is difficult, i.e. the sound intensity drops with I/D while the amplitudes at low frequencies are already quite small. Means to overcome this problem are external/plug-in amplifiers, for example a hands-free car kit connected to the car's stereo.

However, such external/plug-in amplifiers are not always available.

The present invention aims to resolve or at least reduce the cited problem, more in particular to allow an important increase of the sound volume in particular at lower frequencies, without interfering or interfering at least only to a small extent with the main sound function of the mobile device.

To this end the mobile device in accordance with a first aspect of the invention is characterized in that it comprises a display with means for acoustically exciting the display or a part of the display, the mobile device being arranged such that when the mobile device is positioned on a table top as defined in this application, the sound volume at a frequency between 0.5 and 1.5 kHz at a 1 meter's distance from the mobile device is increased by at least 6 dB as compared to the same device when used in air.

The invention is based on the insight that it is possible to vibrate a large rigid object, for example a table top, by means of a much smaller exciter, such that it produces a larger sound than the sound originating from the mobile device if sufficient acoustic coupling is ensured. Depending on the properties of the object to be excited and the acoustic coupling, the sound intensity of the larger object may be larger and richer than that of the exciter alone, presumably because of the much larger surface area of the table when compared to the exciter. Thus even lower frequency sound can be produced even though the excitation amplitude of the table is much smaller (a few nm) than that of the exciter itself (several microns to tens of microns). In order for this to be achieved, a positive large enough acoustic coupling between the sound generating means and the larger object has to be established. In this application this phenomenon is also indicated by the words co-vibration and/or co-excitation.

The manner in which the increase in sound intensity is measured is defined in this application. In short the device is laid on a wooden (plywood) table top having a thickness of 18 mm and a size of 90*180 cm, more or less corresponding to a standard office table, and a force corresponding to a weight of 100 grams is applied to the device while lying flat on the table, with the display parallel to the table, and the increase in sound intensity at a frequency between 0.5 and 1.5 kHz is measured at a 1 meter's distance in respect of the same device when in air, i.e. lying on wool.

In a device in accordance with the invention the display is used as or part of the sound producing means, providing a relatively large sound producing means, which enables relatively low frequency sounds to be produced efficiently. Within the concept of the invention the display itself may have an exciter intrinsically forming a part of the display or may have an exciter (such as a piezo-electric element) coupled to the display for exciting the display or a part of the display. A part of the display may for instance be the cover of the display. To achieve an increase in loudness, in practice the mobile device will probably be positioned on a table top or other flat object, and the sound generated by the mobile device will be acoustically coupled to the flat top surface of the table thus enabling multiple user listening. The device is arranged such that the mechanical coupling offers a sound increase of at least 6 dB at a frequency between 0.5 kHz and 1.5 kHz at a 1 meter's distance when a force corresponding to a weight of at least 100 grams is applied at a more or less standard size table as commonly used in offices.

The 100 grams include the force applied by the device itself. In many instances this will be approximately the weight of the device itself.

In embodiments of the invention the display or its exciter may be arranged such that the display or the display's exciter is in direct contact with a flat surface when laid on a flat surface. This offers a reasonable amount of coupling (offering an increase of approximately 6 to 15 dB) but there is a risk of damage to the display itself or its exciter. In preferred embodiments the mobile device comprises a mechanical coupler near or around the display, one end of which mechanical coupler is in mechanical contact with the display or its exciter, while with an opposite end contact areas are defined with which the device is in contact when laid on a flat surface. In such embodiments the mobile device comprises a mechanical coupler near (preferably attached to) the display to mechanically couple the display (acting as an intrinsic exciter) or the exciter excites the display to vibrate a larger surface.

Using a mechanical coupler very substantial increases in sound intensity, above 15 dB, even above 20 dB, are possible

In preferred embodiments the increase in sound intensity at a frequency between 0.5 and 1.5 kHz is at least 15 dB, preferably at least 20 dB.

Preferably the increase in sound intensity is at least 6 dB for the complete range of frequencies between 0.5 kHz and 1.5 kHz, preferably at least 15 dB, most preferably at least 20 dB.

The mechanical coupler is formed such that it extends slightly beyond the mobile device so that when the device is positioned on the table or other flat surface the mobile device rests on the mechanical coupler. The mechanical coupler itself does not have much influence on the sound intensity of the device when held in hand.

It is observed that to some extent a coupling with a table of sound produced by a conventional mobile device may occur when a mobile device is positioned on a table top or other flat surface which may lead to a change in sound level, either reducing or increasing sound levels. In conventional designs of mobile devices the display is recessed and, when the mobile device is positioned on a table upside-down, hardly any or no contact at all is made with the table near the display, or near the sound generating means, usually the device lies on the buttons, which are in fact good vibration dampers. Consequently, any change in sound level, measured under the same conditions is inaudible, even when brute force is applied (pushing with a full hand), therefore staying typically well below 3 dB at 1 kHz. Given the fact that the device is positioned upside down, a decrease in sound volume is likely. Furthermore, conventional devices do not use displays for producing sounds, and in fact give a very poor sound reproduction at a frequency of 1 kHz. The inventors have realized that by using a sound-producing display a rich sound at lower frequencies is obtainable and with relatively simple and inexpensive means, i.e. either by ensuring direct contact between a flat table top surface and the display or the exciter, or the use of a mechanical coupler increases in sound level of over 6 dB, even over 15 dB, even over 20 dB in preferred embodiments, can be obtained in the region for a frequency between 0.5 kHz and 1.5 kHz. A much richer and better audible sound is obtained. The use of a mechanical coupler, compared to devices with direct coupling presents, an extra increase of some 10-20 dB and a reduction of the risk of damage to the display. It is remarked that the increase in sound volume is an intrinsic property of the mobile device itself, not present in conventional mobile devices, measurable by simple tests explained in the description, and several examples of devices in accordance with the invention are given in the figures enabling a person skilled in the art to perform the invention and to vary, where needed or wanted, the example given in the description, while yet being able to distinguish devices in accordance with the invention, from those beyond the scope of the invention by means of the tests explained.

The standard test with which the increase can be measured is explained in the description of the Figures. Basically, the increase in sound volume is measured at 1 kHz at a 1 meter's distance, while the device is placed, resting on a wooden table of 18 mm thickness, measuring 90*180 cm while the total weight of device plus additional pressure exceeds 100 grams.

In a preferred embodiment the mechanical coupling is arranged such that, when positioned on a flat surface, an attractive force between a flat surface and the mobile device can be established. This feature provides two effects, the display is pressed on the table with some force ensuring that a fixed position and a good mechanical contact is achieved resulting in a good acoustical coupling. In one embodiment the mechanical coupler is formed as a suction cup. A construction similar to the edge of a refrigerator door may be used. In such embodiments non-horizontal objects may be used for sound increase as long as their surface is flat. Therefore, these embodiments may use three dimensional objects such as cabinets to be used for sound increases, i.e. as a co-excitation object as long as the mobile device is attachable to these objects by suction. In practice the user of the device will, after some trials, find the object and position to which he/she can best attach the mobile device for (near)-optimum sound increase given the objects available in the room and their relative position vis-à-vis the user(s). Providing a suction device increases the positions and objects at which the mobile device may be positioned and thus, in general, will increase the ease of use and the maximum available increase in sound intensity.

Alternatively or in addition, in a preferred embodiment the device is provided with a permanent magnet. Sometimes the table top or other surface upon which one wants to affix or place the mobile device is made of metal. Providing the mobile device with a permanent magnet enables the sound increase to be obtained on non-horizontal surfaces too, when such surface is made of magnetisable metal, with or without using suction. Even when the surface is relatively rough, good contact may be made. When an object upon which the mobile device is positioned is made of magnetisable metal, provision of the permanent magnet ensures a good mechanical contact and thereby good acoustical coupling.

In another aspect of the invention the mobile device comprises a display with means for acoustically exciting the display, the mobile device comprises two parts separated by a hinge, one of the these parts comprising the display, and the mobile device comprising an acoustical coupler such that when the device is closed the sound intensity is increased compared to when the device is opened.

This aspect of the invention is based on a recognition similar to the one on which the earlier mentioned aspect of the invention is based. Mobile devices are often designed having two parts that are arranged with a hinge in between, so that the device can be opened or closed. Normally, the device has to be opened before sound is produced. Normally, if one closed the device, the sound intensity of the device would drop noticeably, because the sound was stifled. However, the inventors have realized that it is possible, if an acoustic coupler is used between the two parts, to make the closed device in total a co-excitation object, and in fact increase the sound volume appreciably, compared to the situation when the device is open.

In preferred embodiments the mobile device is provided with a sound recording element and the mobile device comprises a means to establish a comparison between a registered sound and an emitted sound signal and means to indicate that the mobile device is in co-excitation with another object.

Mobile devices such as mobile phones have sound recording means, e.g. a microphone. Feedback between the sound generating means and the sound recording means is considered a major problem and echo cancellation circuits are often used. The inventors have, however, realized that when the device is coupled to another object (or in the case of the two-part mobile device being closed), the sound recording means can be used to increase the effectiveness of the device by comparing the original signal to the recorded sound signal. This comparison can be used advantageously in several ways. In one embodiment the recorded sound is compared to the original sound to redistribute the signals to the display over frequencies. Redistribution of the sound over frequencies may be used for for instance:
1. Obtaining a more natural sound. Apart from increasing the sound intensities the co-excited object will, also change the sound by increasing the intensity more at some frequencies than at others. By redistribution of the intensities over frequencies this can be counteracted. It may even be used to obtain a better, more natural sound than the device per se can give. For instance, the mobile device as such may have only a very limited sound reproducing capability below 1 kHz. Experiments have shown that across the frequency spectrum a substantial increase in sound is obtained. This offers the possibility of a louder sound in all frequencies, but one could also selectively increase the sound at lower frequencies, to obtain a more natural sound. The overall sound increase would then be less than maximum, but the sound would be more natural. A more natural sound is in fact easier to distinguish even at the same overall sound intensity.
2. Obtaining the highest sound intensity possible. Comparing the recorded sound to the emitted sound will enable to establish at which frequencies the sound-increasing effect is most prominent. If the aim is to obtain a sound level as high as possible, most energy may be directed to these frequencies.

In these embodiments the device has a means to establish that the mobile device is indeed used in the “sound increasing” mode. Some simple means for doing so would be some switch or action by which the user sets the device in this mode, or very simply the comparison of sound levels themselves (original vs. recorded) may form the trigger.

In preferred embodiments the device comprises a means to activate the coupling means.

“Activation” within the concept of the invention means any regulation of the acoustic coupling be it on-off or a gradual regulation. When the mobile device is attached to a table top a mechanical coupling is established and the table top stats co-vibrating by which an increase in sound volume is achieved. However, when the device is held against the head, such an effect may not be useful or even be bothersome. Likewise, when the device is lying flat on a table, it could be advantageous to switch off or reduce the acoustical coupling. So, by activating or regulating the mechanical coupling an advantage may be obtained. Such activation may take the form of relatively simple means. For instance, a small inward retraction of the sound generating display or of the mechanical coupling means may have such an effect. The display may also be pushed against mechanical coupling means by springs, in such cases removing the tension from the springs may have a similar effect.

In preferred embodiments the mobile device comprises a part having a further display and the mobile device has means to establish that the mobile device is used in a sound increasing mode and the device has a means to reroute display signals intended for the sound enhancing display to the further display when the mobile device is used in the sound enhancing mode.

Many mobile devices comprise two displays, one for displaying image, and the other for simple messages, such as for instance the telephone number of the other party. When the device is used in the sound increasing mode, the display is often invisible, e.g. when placed “upside-down” on a table top. Rerouting the display signal to the further display, will enable visual images to be displayed on the other display. This further display may be and often is of lesser quality. However, the possibility to send and receive messages by rerouting them to the further display offers the great advantage of communication simultaneously in sound and images, even if the images are of somewhat lesser quality.

These and other objects of the invention will be apparent from and elucidated with reference to the embodiments described hereinafter.

In the drawings:

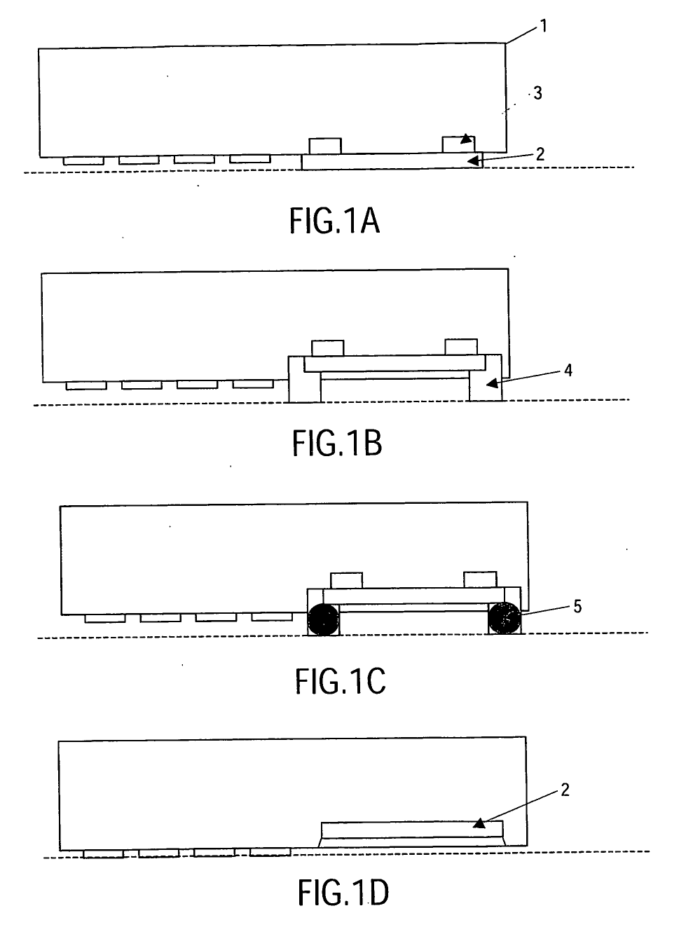

FIGS. 1A, 1B and 1C illustrate schematically mobile devices in accordance with the invention FIG. 1D illustrate a conventional mobile device.

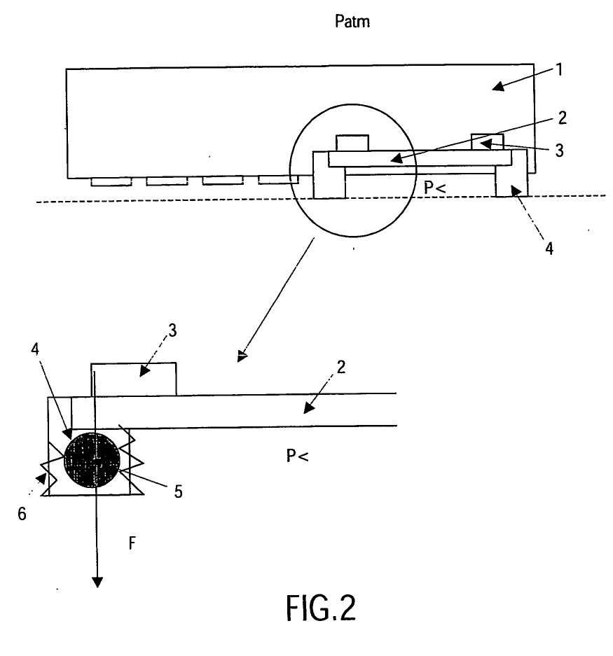

FIG. 2 illustrates schematically a mobile device in accordance with a preferred embodiment of the invention.

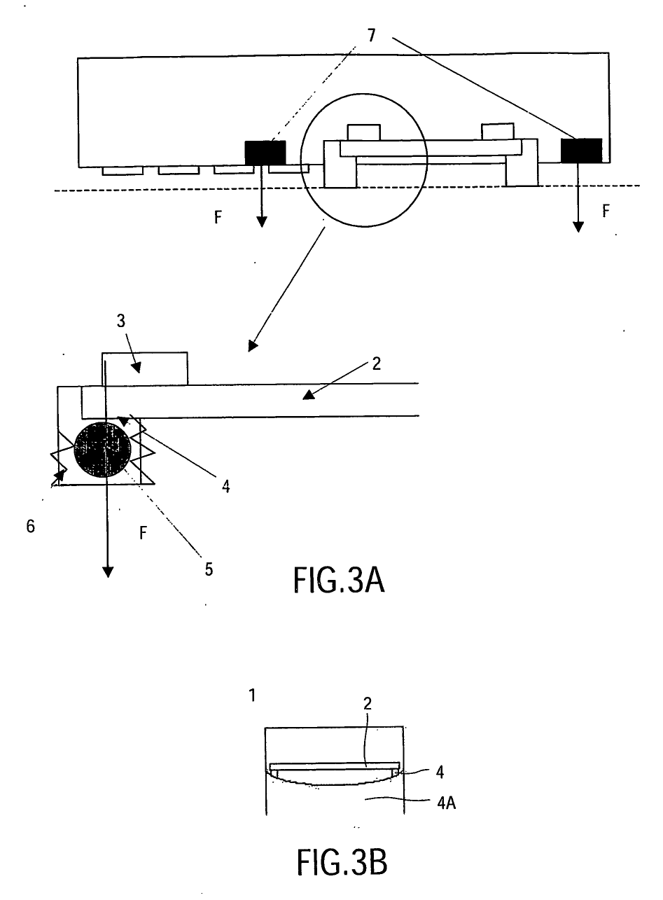

FIGS. 3A and 3B illustrate schematically further embodiments of a mobile device in accordance with the invention.

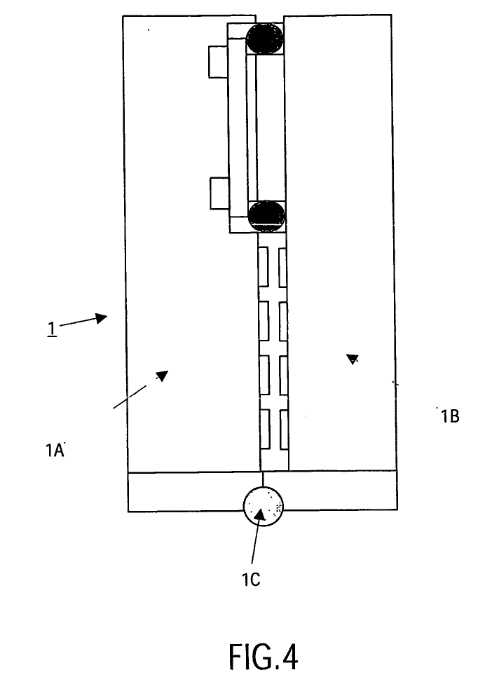

FIG. 4 illustrates schematically yet a further embodiment of a mobile device in accordance with the invention.

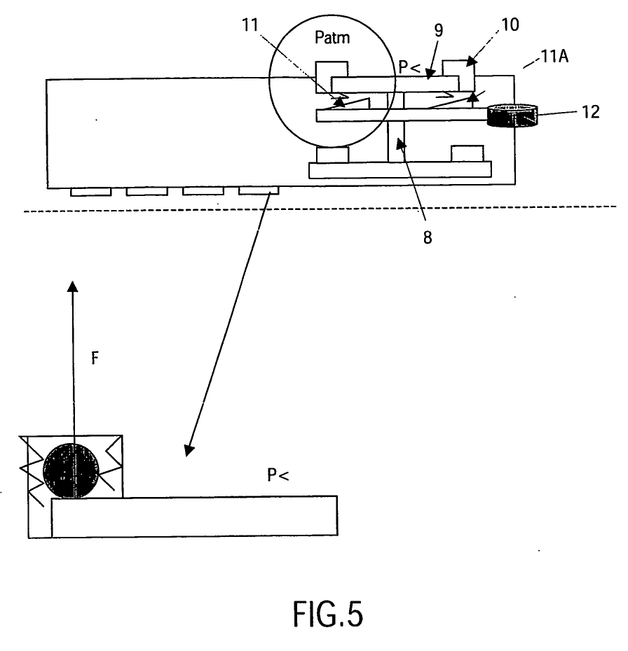

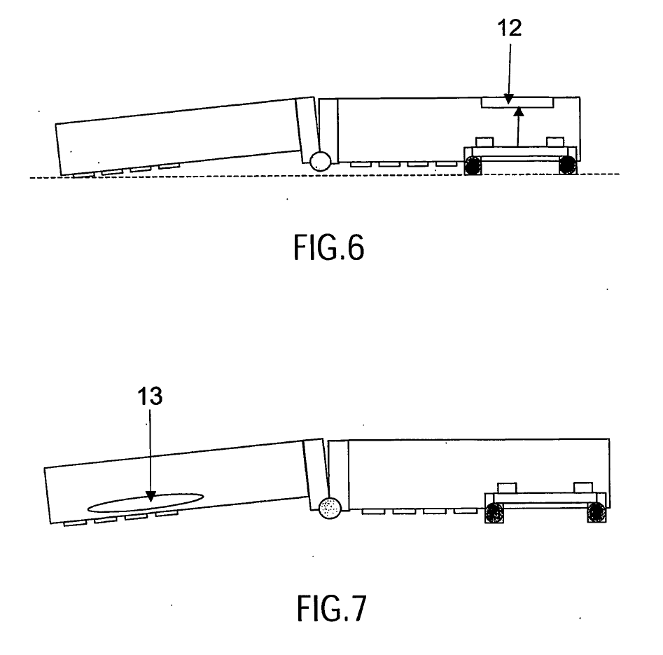

FIG. 5 illustrates a mobile device in which the acoustic coupling means are provided on a side opposite the display FIG. 6 illustrate a mobile device having a further display.

FIG. 7 illustrate a mobile device having a sound recording means.

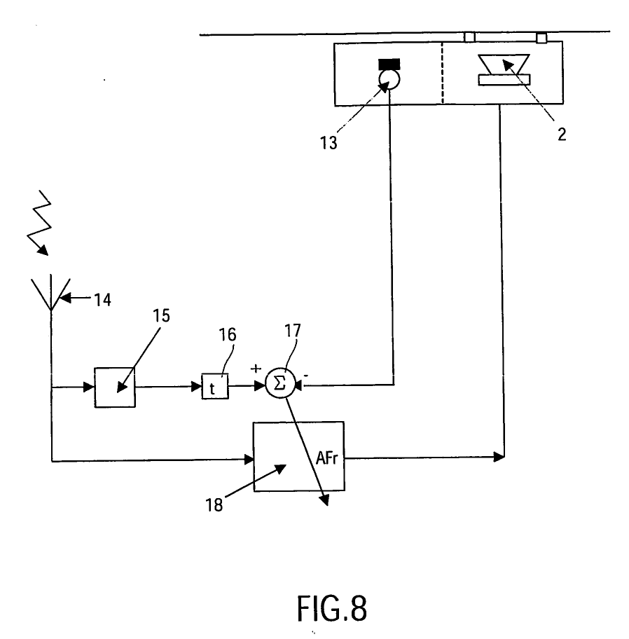

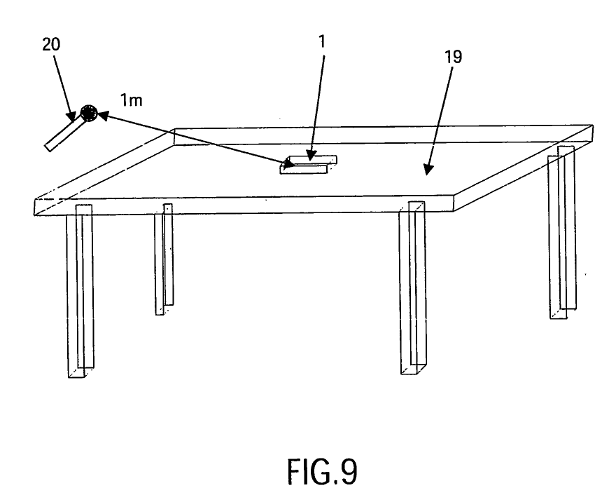

FIG. 8 illustrates a circuit for a device in accordance with a preferred embodiment of the invention.

FIG. 9 illustrates the experimental set-up for measuring sound enhancement by acoustic coupling.

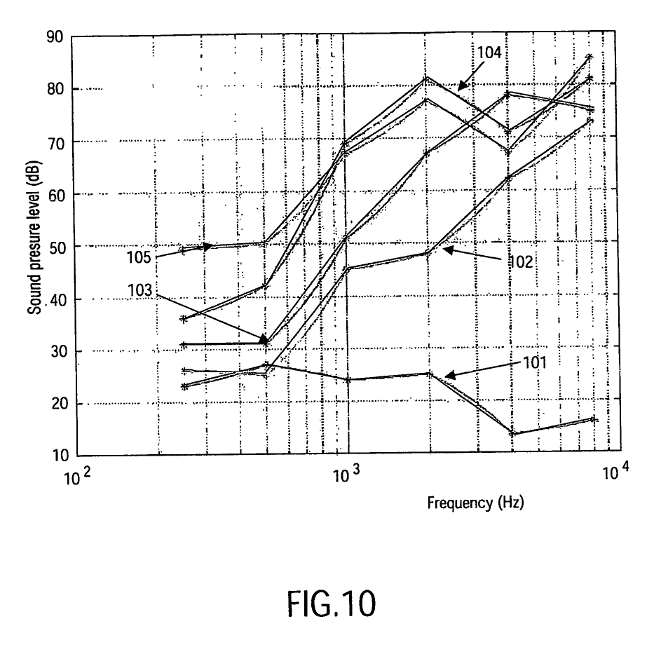

FIG. 10 to 12 illustrate in graphical form the sound enhancement measured with various table tops.

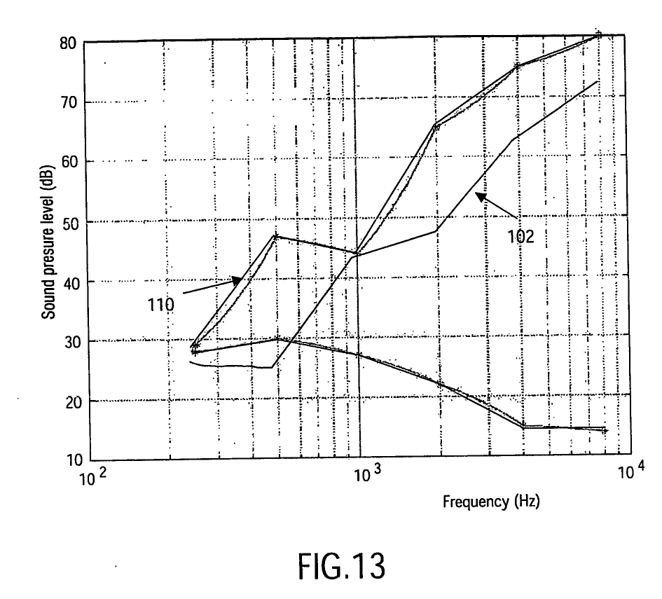

FIG. 13 illustrates the sound enhancement for a two-part mobile device, open and closed.

The figures are not drawn to scale. Generally, identical components are denoted by the same reference numerals in the figures.

The device of the invention comprises a sound generating display. Such sound generating displays are known per se.

Patent application WO-A/00/69212 discloses a small portable electronic device for personal use, such as a personal organizer or a mobile telephone, which article comprises a casing provided with a keypad, a visual display and a transparent cover over the display. The electronic device further comprises a loudspeaker composed of the transparent cover and vibration exciter mounted on the transparent cover, whereby the transparent cover serves as an acoustic radiator.

The display itself may also be used as a loudspeaker. For instance when using a cell type display, such as e.g. an LCD display, or a PALC display or a PDP display, electrodes commonly present in such devices can be used to excite the cell. A vibration of a display cell may be generated by an electrostatic force caused by a voltage difference across opposite electrodes of said cell. By varying the electric voltage across opposite electrodes a varying electrostatic force is generated for radiating sound from the display device, said force varying in a manner related to the varying voltage.

By selectively driving a number of or all the display cells the display device can even be used as a 2D loudspeaker array, offering the possibility to steer a bundle of sound generated by such an array and to control the acoustic directivity. It is possible to generate a narrow bundle of sound.

The display device or its cover may be provided with a piezo-electric exciter to excite the display. The mechanical coupling means may used to establish mechanical coupling between the display and another object or between the exciter (such as a piezo-electric excitor) and another object.

With reference to the Claims, it is to be noted that various characteristic features defined in the set of Claims may occur in combination.

Several embodiments of the mobile device in accordance with the invention are shown in the Figures.

In the first embodiment shown in FIG. 1A, a mobile phone 1 having a sound generating display 2, excited by piezo-electric excitors 3 is designed such that, when placed upside down on a table, schematically indicated by the dotted line, the sound generating display 2 is in direct contact with the table top. In FIG. 1B an embodiment is shown equipped with a mechanical adapter 4, forming a mechanical coupling means. The mechanical coupling means may be provided internally with coupling enhancing means, such as balls or spheres. Despite its low weight prototypes showed that sufficient mechanical coupling exists between the display and the table, giving a higher volume, well over 6 dB more and a richer sound was evident when compared to the mobile device in air. In one case, a piezo-electrically driven LCD was coupled to the table by means of hard rubber rim 4 placed along the circumference.

The display may either be in direct contact with the table or via a mechanical coupler. In mobile devices where the display lies in a recessed position within the device (see FIGS. 1B and 1C) the use of a small mechanical coupler, extending beyond the mobile device's surface, enables a good acoustic coupling to be established, in particular when for example 2 or 3 point contacts are embedded in a rubber rim. Here too, larger and richer sound levels were produced by the table in the experimental set-up.

FIG. 1D schematically shows a conventional mobile phone. Conventionally the display is somewhat recessed within the device. When placed upside-down on a table the protruding parts, i.e. the buttons, are the parts on which the device rests. These buttons are not close to the display and in fact acts as dampers of sound, resulting in a very poor, if at all acoustic coupling. Even when brute force is applied to press such known devices on a table top, no audible improvement in sound level is heard. The human ear will clearly distinguish a sound increase of 3 dB. Given the fact that the buttons in fact act as dampers and the device is positioned upside down, a decrease in sound volume is likely.

The volume of the produced sound can be enhanced even further when the device has means for applying a force to press the device against a table. A good mechanical contact may then be established between the device and the table or other object to be co-vibrated. In order to enable this a suction cup may be provided on the mobile device, for instance using the properties of the very well-known refrigerator-door seal. Here a seal is used that creates a slightly lower pressure within the rim after the door has been closed. Thus the seal (the lower pressure) “clamps” the door to the refrigerator. In incorporating a mini-version of such a seal along the periphery of the display a firmer contact between the mobile device and the table can be provided. In the case of a recessed display one or more solid objects are preferred to be incorporated within the seal so that a good mechanical contact between the display and the phone is established. An example of such a mobile device is schematically shown in FIG. 2. The device has a suction cup 4, having harmonica like walls 6 inside of which there are hard spheres. By slightly pressing on the suction cup air is pushed out and a partial vacuum (P<) is established. The difference between the partial vacuum P<and the atmospheric pressure Patm establishes a force F pushing the mobile device against the table. This force has two effects: the display is pressed with some force on the table ensuring a fixed position and a good mechanical contact is achieved resulting in a good acoustic coupling. In one embodiment the mechanical coupler is formed as a suction cup. A further advantage is that the force establishes a good mechanical contact via the hard objects 5. When not pressed on the table, but for instance held against the ear, the force F is not established and no acoustic coupling is achieved. In FIG. 3A a variation on the design shown in FIG. 2 is given. In this embodiment the device is provided with magnets, preferably permanent magnets 7. When placed against a metal object, the magnets provide for an attractive force, establishing a good acoustic contact between the metal object and the mobile device. When held against the ear, no such effect occurs. The magnets may be magnets 7, as shown in this figure. Alternatively the hard objects 5 may be magnets, this would have the effect that the magnets are closer to the table.

The mobile device may be in the form of a kit or assembly comprising the device and a separate adapter to fit the device around the display. The advantage is that the design of the device (design aspects are often an important aspect of sale) need not be altered. The disadvantage is that here a separate body is required which may get lost/be forgotten.

For mobile devices such as mobile phones having a curved outer circumference, an adapter 4A of inverse shape may be used to support the display (see FIG. 3B). However, in this case, the cover is often curved, and, as yet, not the display. As such a mechanical coupling between the cover and the display is required as well. FIG. 3 B shows a cross-sectional view in the case of a curved display, or display having a curved protective cover. The invention also relates to a device having such an acoustic adapter and to an acoustic adapter for use in such a device. The acoustic adapter itself may perform as an acoustic filter, enhancing certain frequencies.

FIG. 4 shows an alternative embodiment of the invention based on the same insight. It is not always possible to find a suitable co-vibrating object, e.g. when only extremely heavy objects are available. FIG. 4 shows a further aspect of the invention. The mobile device comprises a display with means for acoustically exciting the display. The mobile device comprises two parts 1A, 1B separated by a hinge 1C, one of these parts comprises the display, and the mobile device comprises an acoustic coupler such that when the device is closed the sound intensity is increased compared to when the device is opened.

This aspect of the invention is based on a recognition similar to the one on which the earlier mentioned aspect of the invention is based. Mobile devices are often designed having two parts that are arranged with a hinge in between, so that the device can be opened or closed. Normally the device has to be opened before sound is produced. Normally, if one would close the device, the sound intensity of the device will drop noticeably, because the sound is stifled. However, the inventors have realized that it is possible, if an acoustic coupler is used, to use the closed device in total as a co-vibrating object, and to increase the sound volume appreciably. This is in particular useful for MP3 playback and for ringtone playback.

FIG. 5 illustrates a further embodiment of a mobile device in accordance with the invention. The mobile device comprises a coupler 8 which couples the display to a (part of) the back side 9 of the device. This part is provided with a mechanical coupler 10. Underneath the part 9 there are springs 11, by twisting or pressing on a knob 12, these springs may be activated to press the part 9 against the mechanical coupler 10. In this manner the mechanical coupling may be activated or deactivated. In embodiments the amount of pressure may be regulated by means of the position of the wedges 11A, so that the amount of mechanical coupling and there the sound volume may be regulated.

FIG. 6 shows a mobile device having two parts laid open on a table top. In this embodiment the device has a further display 12. When the device is used in the sound increasing mode the device has means to establish that this is the fact and reroutes the images from the sound generating display to the further display. The means for establishing that the device is used in a sound increasing mode may be various:
1. a button which the user may press
2. a position indicator inside the device (a simple switch which operates on gravity)
3. a sound check (just as a human can clearly hear the increase in sound level, so can the microphone that such device conventionally comprises).

FIG. 7 is similar to FIG. 6 except that it shows a microphone 13.

FIG. 8 illustrates a preferred embodiment of the device in accordance with the invention. The incoming signal is received via antenna 14. The signal is sent via a filter 18 with filter constants AFr to the display 2, which is here indicated as a loudspeaker. The signal recorded by the microphone 13 as the sound recording means, is compared in comparator 17 to the incoming signal or a derivative thereof. The incoming signal may be filtered in filter 15 and delayed in delayer 16.

This comparison can be used advantageously in several manners. In one embodiment the recorded sound is compared to the original sound to redistribute the signals to the display over frequencies. Redistribution of the sound over frequencies may be used for for instance:

Obtaining a more natural sound. The co-vibrating object may, apart from increasing the sound intensities, also change the sound by increasing the intensity more at some frequencies than at others. By redistribution of the intensities over frequencies this can be counteracted. It may even be used to obtain a better, more natural sound than the device per se can give. For instance, the mobile device as such may have only a very limited sound reproducing capability below 1 kHz. Experiments have shown that across the frequency spectrum a substantial increase in sound is obtained. This offers the possibility of a louder sound in all frequencies, but one could also selectively increase the sound at lower frequencies, to obtain a more natural sound. The overall sound increase would then be less than maximum, but the sound would be more natural. A natural sound is in fact easier to distinguish even at the same overall sound intensity.

The feedback loop then acts as an equalizer. The sound intensity of the device in air drops sharply for lower frequencies when the device is used in air, the device according to the invention boosts the sound intensity at lower frequencies, comparing the incoming signal and the signal recorded by the microphone enables (at least with a range of frequencies) to equalize the sound intensities. This will be further discussed in relation to FIG. 10.

Obtaining the highest sound intensity possible. Comparing the recorded sound to the emitted sound will enable to establish at which frequencies the sound increasing effect is most prominent. If the aim is to obtain a sound level as high as possible, most energy may be directed to these frequencies.

FIG. 9 schematically indicates the manner in which the sound increase is measurable. The mobile device 1 is positioned on a table 19, in the proper orientation, i.e. if it has a protruding display with the display lying on the table, and if it has a mechanical coupler with the coupler on the table, and if the device has a suction cup, with suction action.

The sound level at a 1 meter's distance at a frequency between 0.5 kHz and 1.5 kHz is measured. The mobile device is removed and placed on a woolen cloth or suspended in air. The sound level is again measured using of course the same signal. The sound levels at a frequency between 0.5 kHz and 15 kHz are compared. If the sound level increase for any frequency within that range (0.5 to 1.5 kHz) is more than 6 dB, the device falls within the scope of the claim, if not, outside. Preferably the increase is at least 15 dB, more preferably at least 20 dB. Preferably the increase in sound intensity is at least 6 dB throughout the range between 0.5 kHz and 1.5 kHz. The table has a wooden (plywood) table top of 90*180 cm with a thickness of 18 mm. This corresponds more or less to a standard table top in offices.

FIG. 10 illustrates the measured values for sound level (the y-axis) as a function of frequency (the x-axis). Line 101 gives the background noise, line 102 the device when in air. In this case a mobile device using a display excited by a piezo-electric exciter was used. Line 103 illustrates the increase in sound when the display is in direct contact with the table top. At 0.5 kHz a 6 dB increase, at 1 kHz a 7 dB increase and at 1.5 kHz a 12 dB increase in sound intensity is measured. Line 104 illustrates the use of a mechanical coupler (a rubber rim with hard parts) A much higher sound volume is obtained, at 0.5 kHz an increase of 17 dB, at 1 KHz an increase of 24 dB, and at 1.5 kHz an increase of 33 dB is obtained. Line 105 illustrates the effect of pushing the piezo-electric excitor directly on the table. Increase of 25 dB (0.5 kHz), 22 dB (I kHz) and 28 dB (1.5 kHZ) are obtained. The increases at low frequencies, i.e. between 500 Hz and 3 kHz are very remarkable. Line 102 shows that the sound intensity of the device in air drops sharply when comparing frequencies above 3 kHz to lower frequencies. Lines 104 and 105 show a considerable increase in sound intensity. These lines also show that the sound increase shows some fluctuations. Using the feedback loop of FIG. 8, and comparing the original signals with the signals recorded by the microphone, the sound levels may be pegged on a constant value (for instance 70 dB) throughout the range between 1 and 3 kHz and higher. Increasing the signal at lower frequencies will even enable to equalize the sound intensities to somewhat lower frequencies (e.g. to 800 Hz) and have intensities approaching this level up to 500 Hz. Thus using the feedback loop of FIG. 8, the sound level intensities may be equalized giving a much more natural sound, increasing not only the sound intensity appreciably (by more than 6 dB, even more than 15 dB) but also the sound quality. Since the sound intensities at lower frequencies are not only increased but also equalized, it is possible to obtain 70 dB throughout the frequency range from 1 to 3 kHz and beyond. As this and further figures show, different table tops have, although grosso modo similar increases in sound intensities are obtained, somewhat different characteristics. The feedback-loop of FIG. 8, enables to equalize the sound reproduction independent of the table top used, which has the added advantage that the sound quality is more constant, whatever surface is used for co-vibration.

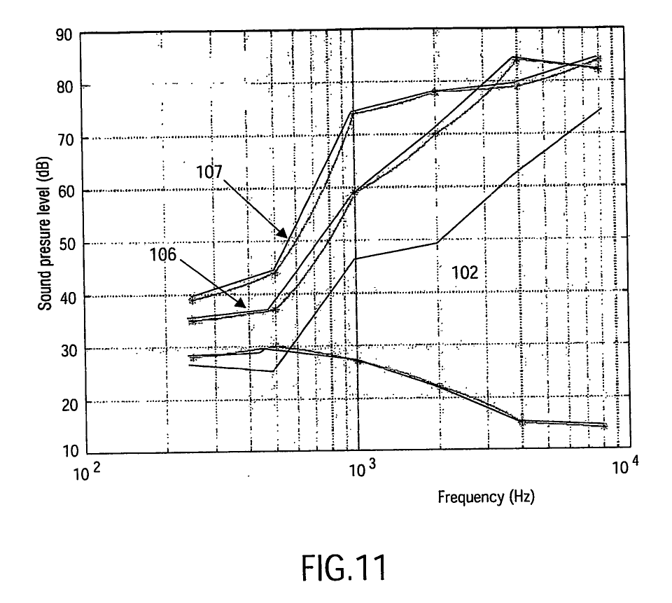

In the standard test a table having a plywood table top of 18 mm and a size of 90*180 cm is used. However, this is merely for the purpose of establishing a benchmark. FIG. 11 shows the result of a measurement in which a table of 14 mm plywood and size 160*80 cm was used. Line 102 is again the device in air, line 106 the device with the display in direct contact with the table, and 107 with the use of a mechanical coupler. The increase in sound level at 1 kHz is 12 respectively 32 dB.

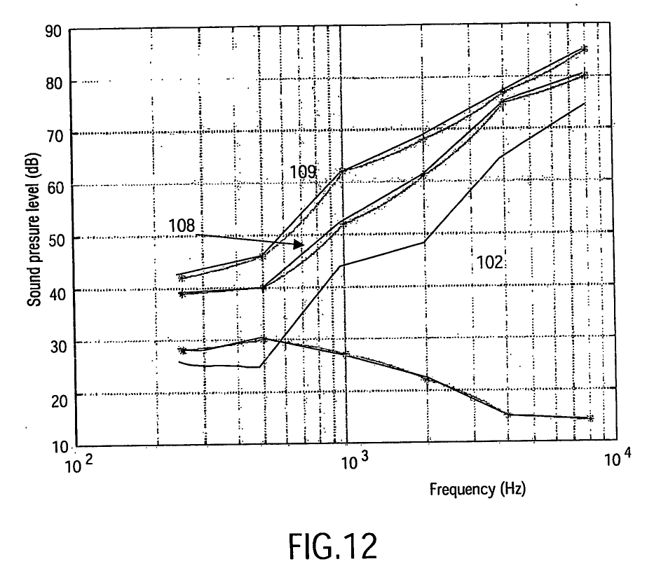

FIG. 12 shows the results for a table with a steel table top and size 100*200 mm.

Line 102 is again the device in air, line 108 the device with the display pressed against the table top, line 109 with the use of a mechanical coupler. The increase in sound intensity is 8 respectively 19 dB. The force applied to the mobile device is 100 grams or more, including the weight of the device. Pushing harder does not really increase sound levels by any appreciable degree. Experiments with conventional mobile phones showed, that however hard the mobile phones were pressed on the table, and in whatever position, for all these three tables, no audible increase in intensity for whatever mobile phone was heard, whereas the increases in intensity for each of the embodiments of the mobile devices in accordance with the invention for each of the tables were very clearly audible. Comparing the three FIGS. 10, 11 and 12 it is clear that the sound level increase, as well as grosso modo the amount of increase is a characteristic of the mobile device in accordance with the invention. The standard of the plywood table with the specified measures is used to establish a frame of reference, the values for other types of table top are grosso mode similar.

FIG. 13 illustrates the sound levels for a device comprising two parts. A substantial increase in sound levels is measured. In this particular case, a simple prototype, the sound increase at 1 kHz is small, however, at other low frequencies the sound level increase is very noticeable, namely 20 dB at 0.5 kHz and 18 dB at 1.5 kHz. This device thus shows an increase of at least 6 dB at a frequency between 0.5 and 1.5 Khz (within the framework of the invention “at a frequency between 0.5 and 1.5 kHz” includes the limits 0.5 and 1.5 kHz). Standard mobile phones or mobile acoustic devices show a decrease in sound level if they operate at all when closed.

It will be clear that within the framework of the invention many variations are possible. It will be appreciated by persons skilled in the art that the present invention is not limited by what has been particularly shown and described hereinabove. The invention resides in each and every novel characteristic feature and each and every combination of characteristic features. Reference numerals in the claims do not limit their protective scope. Use of the verb “to comprise” and its conjugations does not exclude the presence of elements other than those stated in the claims. Use of the article “a” or “an” preceding an element does not exclude the presence of a plurality of such elements.

1. Mobile device having a sound generating means and a display, characterized in that the mobile device (1) comprises a display (2) with means (3) for acoustically exciting the display or a part of the display, the mobile device being arranged such that when the mobile device is positioned on a table top as defined in this application, the sound volume at a frequency between 0.5 kHz and 1.5 kHz at a 1 meter's distance from the mobile device is increased by at least 6 dB as compared to the same device when used in air.

2. Mobile device as claimed in claim 1 characterized in that the sound level increase is at least 15 dB.

3. Mobile device as claimed in claim 1, characterized in that the sound level increase is at least 20 dB.

4. Mobile device as claimed in claim 1, characterized in that the sound intensity is increased by at least 6 dB throughout the range of frequencies between 0.5 kHz and 1.5 kHz.

5. Mobile device as claimed in claim 1, characterized in that the mobile device is provided with a mechanical coupling means (4).

6. Mobile device as claimed in claim 4, characterized in that the mechanical coupling is arranged for, establishing an attractive force (F) between a flat surface and the mobile device when positioned on a flat surface.

7. Mobile device as claimed in claim 5, characterized in that the mechanical coupling means is a suction cup (4).

8. Mobile device as claimed in claim 5, characterized in that the mobile device comprises one or more magnets (7, 5).

9. Mobile device as claimed in claim 4, characterized in that the mechanical coupling means is a flexible ring comprising hard parts (5).

10. Mobile device as claimed in claim 1 comprising an acoustic adapter.

11. Acoustic adapter for use in a mobile device as claimed in claim 10.

12. Mobile device having a sound generating means and a display, characterized in that the mobile device comprises a display (2) with means (3) for acoustically exciting the display, the mobile device comprises two parts (1A, 1B) separated by a hinge (1C), one (1A) of the these parts comprising the display, and the mobile device comprises an acoustic coupler (4) such that when the device is closed the sound intensity is increased compared to when the device is opened.

13. Mobile device as claimed in claim 1, characterized in that the mobile device is provided with a sound recording element and the mobile device comprises a means to establish a comparison between a registered sound and an emitted sound signal and means to indicate that the mobile device is co-vibrating with a further object.
